(19) United States
(12) Patent Application Publication
(10) Pub. No.: US 2016/0053164 A1
(43) Pub. Date: Feb. 25, 2016

(54) HYDRAULIC FRACTURING APPLICATIONS EMPLOYING MICROENERGETIC PARTICLES

(71) Applicant: BAKER HUGHES INCORPORATED, Houston, TX (US)

(72) Inventors: D.V. Satyanarayana Gupta, The Woodlands, TX (US); Randal F. Lafollette, Conroe, TX (US)

(73) Assignee: BAKER HUGHES INCORPORATED, Houston, TX (US)

(21) Appl. No.: 14/831,510

(22) Filed: Aug. 20, 2015

Related U.S. Application Data
(60) Provisional application No. 62/040,441, filed on Aug. 22, 2014.

(51) Int. Cl. C09K 8/80; C06B 43/00; E21B 43/263

(52) U.S. Cl. CPC C09K 8/805; E21B 43/263; C06B 43/00

(57) ABSTRACT

Microenergetic particles can be employed in hydraulic fracturing of oil or gas wells. By exciting the microenergetic particles, an operator performing a fracture job can better map the fracture process and/or increase the extent of fracturing over what can be accomplished using only pumps. By deploying microenergetic particles during the fracturing of an oil or gas well, but not exciting the microenergetic particles until there is a reduction of production, an operator can extend the time periods between well stimulations.

### CROSS REFERENCE TO RELATED APPLICATIONS

This application claims priority from the U.S. Provisional Patent Application having the Ser. No. 62/040441 which was filed on Aug. 22, 2014 and which application is incorporated herein in its entirety by reference.

### STATEMENT REGARDING FEDERALLY SPONSORED RESEARCH AND DEVELOPMENT

This invention was made under a CRADA TC02201.0 between Baker Hughes Incorporated and Lawrence Livermore National Laboratory operated for the United States Department of Energy. The Government has certain rights in this invention.

### BACKGROUND OF THE INVENTION

1. Field of the Invention

The invention relates to a method of producing crude oil or natural gas. The invention particularly relates to a method of producing crude oil or natural gas using hydraulic fracturing.

2. Background of the Art

Oil or natural gas from hydrocarbon bearing earth formations is usually first produced by the inherent formation pressure of the hydrocarbon bearing earth formations. In some cases, however, the hydrocarbon bearing formation may become blocked and then the formation lacks sufficient inherent pressure to force the crude oil or natural gas from the formation upward to the surface. In other cases, while there is sufficient pressure in place, the formations may be producing hydrocarbons too slowly to be economical.

In one extreme version of the latter case, a shale formation, not even natural gas can be produced by simple drilling and perforation methods. For example, the characteristics of shale reservoirs may typically be described as having extremely low permeability (100-600 nano-darcys), low porosity (2-10%), and moderate gas adsorption (gas content 50-150 scf/ton).

In all of these situations, it may be desirable to stimulate production by means of hydraulic fracturing. Where a well has become blocked but the formation and reservoir are otherwise in good condition, it may be desirable to merely isolate the production zone or zones of the well and perform hydraulic fracturing. Where the formation and or the reservoir are not in a condition such that economic production is so simply restored or created, in order to achieve economical production and enhance productivity, large numbers of horizontal wells and massive multistage hydraulic fracturing treatment (HFT) jobs may be required. This is actually typical with a shale reservoir.

It would be desirable in the art of producing crude oil and natural gas to more efficiently employ hydraulic fracturing by including a microenergetic particle within the proppant used for the hydraulic fracturing.

### SUMMARY OF THE INVENTION

In one aspect, the invention is a method for performing hydraulic fracturing on an oil or gas well comprising including microenergetic particles with the fluids and solids injected downhole during hydraulic fracturing of the oil or gas well.

In another aspect, the invention is a composition useful for performing hydraulic fracturing of an oil or gas well comprising a member selected from the group consisting of proppants, gelling compounds, gel breakers, and combinations thereof, and energetic particles at a concentration sufficient to improve at least one aspect of hydraulic fracturing of an oil or gas well performed therewith.

In still another aspect, the invention is a method for performing hydraulic fracturing on an oil or gas well comprising admixing microenergetic particles with fluids and solids injected downhole during hydraulic fracturing of the oil or gas well and then exciting the microenergetic particles such that at least some the particles release energy. The excitation of the particles may occur during the hydraulic fracturing process or it may be delayed.

### BRIEF DESCRIPTION OF THE DRAWINGS

The features and advantages of the present invention will become more apparent by describing in detail embodiments thereof with reference to the attached drawings in which:

FIG. 1 is a flow chart showing a first embodiment of a method of the Application;

FIG. 2 is a flow chart showing a second embodiment of a method of the Application;

FIG. 3 is a flow chart showing a third embodiment of a method of the Application; and

FIG. 4 is an illustration of section of an oil or gas reservoir which has been subjected to hydraulic fracturing according to one embodiment of a method of the Application.

### DETAILED DESCRIPTION

In one embodiment, the invention is a method for performing hydraulic fracturing on an oil or gas well comprising including microenergetic particles with the fluids and solids injected downhole during hydraulic fracturing of the oil or gas well. For the purposes of this application, the microenergetic particles (MEP) are those that have the following properties. The MEPs have sufficient potential energy that once disposed downhole, they may be excited to release their potential energy and, once released, the energy is of a kind and of an amount sufficient to improve at least one characteristic of the hydraulic fractures. Further, the MEPs may be deployed without releasing their energy at a level that would make the fracturing process unsafe. Finally, the MEPs have the property of being able to be excited either directly from the surface or by deploying a chemical agent or a force in a wellbore. Exemplary forces include, but are not limited to an electromagnetic force or a pressure wave in the wellbore of the oil or gas well being subjected to hydraulic fracturing.

In at least one embodiment, the MEPs are excited using the force of the hydraulic fracturing pressure that is transferred to the geological formation being fractured. Once the MEPs are in place within fractures, the MEPs are excited by the pressure of the formation closing upon them at the cessation of hydraulic fracturing.

While in some embodiments the MEPs may be employed as neat particles of an explosive or propellant, in other desirable embodiments it may be advantageous to encapsulate the explosive or propellant or to apply the explosive or propellant to a support. Using a support for the MEPs is particularly useful when the pure or neat explosive or propellant would be too small to be easily admixed or otherwise incompatible with the other components of the fracture materials being employed during the hydraulic fracturing process.

Supports can include any that are compatible with the explosive or propellant being used. For example, if the explosive or propellant includes a group that forms a ligand with alumina, then alumina may be used. Any metal or other material that can form such a ligand could be used. The process for supporting such compounds is well known.

In one especially desirable embodiment, the explosives or propellants may be encapsulated. Encapsulation may be used to either make the explosive or propellant more sensitive or less sensitive. In one embodiment of the application, the encapsulation material is selected such that it will disintegrate or otherwise release the explosive or propellant after the start of the hydraulic fracturing process. In some of the embodiments, the release occurs immediately allowing for the explosive or propellant to be excited all at once. In other embodiments, the release occurs continuously over time so that the explosive or propellant may be excited during the course of the hydraulic fracture process. In still other embodiments, at least part of the explosive is not released until after the completion of the hydraulic fracture process.

One method of encapsulating explosives and propellants which may be used with some embodiments of the method of the application is that published in the paper titled ENCAPSULATED LIQUID SORBENTS FOR CARBON DIOXIDE CAPTURE by John J. Vericella, et. al., in Nature Communications, in press 2014. Therein it is disclosed that Polymer microcapsules are produced using a double capillary device that consists of an outer square glass capillary (0.9 mm inner wall), an inner circular capillary (0.70 mm inner diameter, 0.87 mm outer diameter) that has been flame polished, and a final circular capillary that has been pulled to a fine tip. The pulled tip is drawn down using a laser tip puller to a final diameter of 30-40 μm. The two round capillaries are inserted into the square glass capillary approximately 100-300 μm apart. Epoxy is used to bond syringe tips to the capillaries and hermetically seal the device to the glass slide.

The resulting microcapsules are novel carbon capture media composed of polymer microcapsules with thin-walled, CO₂-permeable solid shells that contain a liquid sorbent core. They are produced by co-flowing three fluids: (1) aqueous carbonate solution (inner fluid) for the carbon capture solvent, (2) a hydrophobic photopolymerizable silicone (middle fluid) (Semicosil 949UV, Wacker Chemie AG, Munich, Germany) for the shell material, and (3) an aqueous carrier fluid with surfactant (outer fluid).

During microcapsule assembly, the inner and middle fluids are co-flowed down a channel separated by a tapered glass capillary counter flowing to a third fluid, where they form a double emulsion droplet at the outlet at rates of 1-100 Hz. Flow rates of the inner, middle and outer fluids are pumped (PHD 2000, Harvard Apparatus, Holliston, Mass.) at flow rates between 2-5 mL/hr depending on desired capsule geometry. After formation, the droplets exit the device and are collected in fluid (0.5 wt % Pluronic F127 solution) and cured under ultraviolet (UV) light (λ=365 nm). After curing, the polymerized microcapsules can be transferred and handled with relative ease.

Rather than using this process to microencapsulate a sorbent, this process can be used instead by substituting a solid explosive or propellant for the sorbent to encapsulate the explosive or propellant for use with the method of the application.

Another method that may be employed to prepare the MEPs of the application is that disclosed in Monodisperse Double Emulsions Generated from a Microcapillary Device, A. S. Utada, et al.; Science 308, 537 (2005). Therein, it is disclosed that:

Double emulsions are highly structured fluids consisting of emulsion drops that contain smaller droplets inside. Although double emulsions are potentially of commercial value, traditional fabrication by means of two emulsification steps leads to very ill-controlled structuring. Using a microcapillary device, we fabricated double emulsions that contained a single internal droplet in a coreshell geometry. We show that the droplet size can be quantitatively predicted from the flow profiles of the fluids. The double emulsions were used to generate encapsulation structures by manipulating the properties of the fluid that makes up the shell. The high degree of control afforded by this method and the completely separate fluid streams make this a flexible and promising technique.

By replacing the “internal droplet” with a particle of explosive or propellant, the resulting encapsulated explosive or propellant could be used with the method of the application.

In another embodiment, the method disclosed in the US. Patent Application having the Publication No. 2013/0017610 may be used. Therein, a round injection tube that tapers to some opening, typically with an opening diameter from 1-1,000 micrometers (μm), is inserted and secured into a square outer tube wherein the outer diameter (OD) of the round tube, which is typically 0.8-1.5 millimeters is slightly smaller than the inner diameter (ID) of the square outer tube in order to center the round injection tube within the square outer tube. A round collection tube with an opening diameter typically 2-10 times larger than the opening of the injection tube and an OD equivalent to the injection tube is inserted into the opposite end of the square outer tube typically to within 100-800 μm of the injection tube and secured in place. Liquid-tight connections are made to deliver the inner (core) fluid to the injection tube, the middle (shell) fluid to the interstitial space between the round injection tube and the square outer tube, and the outer (collection) fluid to the interstitial space between the round collection tube and the square outer tube.

Each fluid is delivered with a controlled volumetric flow rate where flows for the middle and outer fluids are typically 10-1000 times the inner fluid flow rate with typical flow rates on the order of 100-1000 μm. In operation, the inner fluid, with a viscosity of 1-1,000 (cP), flows in the injection tube. As the inner fluid proceeds down the channel it passes through the tapered injection tube which is a droplet forming nozzle. The formed droplet is released from the nozzle and becomes encased in a spherical shell of the middle fluid; which has a viscosity of 10-100 times that of the inner fluid.

The inner fluid droplet becomes encased in the middle fluid forming an encapsulated microcapsule that has a core with a thin outer shell. The outer fluid, with a viscosity of 10-100 times the inner fluid, flows in the outer tube and hydro dynamically flow focuses to sever and form the microcapsules at the active zone between the injection tube opening and downstream up to several millimeters within the collection tube. This outer fluid carries the microcapsules into a collection container. The microcapsules can range from approximately 10-1,000's μm in diameter with shell thicknesses that range from approximately 5-25% of the capsule diameter. Both the diameter and the shell thickness are tunable by changing the microfluidic geometry or the fluid viscosities and flow rates.

This reference further discloses that the shell may be treated so that it undergoes a liquid to solid transition via routes such as photocrosslinking and interfacial polymerization. In addition, multiple devices may be stacked in sequence or multiple devices may be fed into a single device so that capsules within capsules may be formed with different inner fluids contained within each capsule while also controlling the number of capsules within a larger capsule.

The explosives and propellants of the application may also be incorporated into the capsules and capsules within capsules of the 2013/0017610 reference in place of the tracers disclosed therein. In fact, any method of encapsulating compounds such as the explosives and propellants useful with the method of the application known to those of ordinary skill in the art may be useful with the methods of the application.

The propellants and explosives useful with the method of the application include any that meet the criteria set forth above. Such compounds include but are not limited to nitro-aromatics such as trinitrotoluene and trinitrophenol but also includes nitramines such as cyclotetramethylenetetranitramine (also known as HMX), aliphatic nitro compounds such as nitrocellulose, nitroglycerine, and nitrated polyols; hydrazines and other non-nitro-group including materials such as perchloric acid, powdered aluminum, powdered magnesium and the like.

In other embodiments, the explosive or propellant may be selected from the group consisting of dinol, dinitrodihydroxydiazobenzene salt (diazinate), dinitrobenzofuroxan salts, perchlorate or nitrate salt of metal complexes of ammonium, amine, and hydrazine. An exemplary propellant would be a mixture of 2-(5-cyanotetrazolato)pentaaminecobalt (III) perchlorate (CP), and various diazo, triazole, and tetrazole compounds.

The MEPs, whether including a capsule or substrate or not, are admixed with the fracturing fluids and or proppants used for hydraulic fracturing. Typically, the MEPs will be admixed with the proppants. In some embodiments, the MEPs may be added to the proppants prior to the proppants being mixed with the fluid (liquid, foam, gas or compressed gas) components of the fracturing fluid system to be used. In some embodiments, it may be desirable to admix the MEPs with the proppant after the proppant has been admixed with fluids. For example, if the proppant were a ceramic, it may be desirable not to expose the MEPs to the surface of the ceramic until it has been wetted to avoid premature excitation of the MEPs.

In another embodiment, the MEPs are not admixed with the proppant but are instead pumped ahead of the proppant containing portion of the fracturing fluid as in a pad fluid. In another embodiment, the MEPs are pumped in a fluid as a stage in between proppant stages. For purposes of this Application, any material introduced downhole during or in preparation for hydraulic fracturing is a fluid and/or solid injected downhole during hydraulic fracturing.

Where the MEPS are to be employed in the hydraulic fracturing process is sometimes a function of their intended purpose. For example, one way in which the MEPs of the application may be employed is in allowing for the better control of the fracturing process. In a conventional fracturing process, sometimes micro-seismic monitoring systems are put in place to monitor the extent of fracturing. As the fracture fluids and proppants are forced into the formation being subjected to fracturing, the sounds that are created as the rock is stress-relieved can sometime be heard using micro-seismic monitoring systems to allow for better estimation of how far from the wellbore the fractures are extending.

In the course of employing the methods of the application, in some embodiments, the MEPs are excited to produce sound which is more easily detected by the micro-seismic monitoring systems after the completion of the fracturing treatment and when the formation closes on the proppant (as already noted above). This would allow for a more accurate determination of the geometrical extent of the propped fracture. Since the fractures produced during hydraulic fracturing can run for more the 2,000 feet, it would be desirable to have a “louder” event than merely stress-relieving the formation for the seismic systems to detect. This aspect of the method the application would allow for much more accurate fracture mapping. Since the MEPs are pumped along with the proppant, the sound produced by the excited MEPs when monitored can locate the proppant pack location which results in improved fracture mapping.

In another embodiment, the MEPs of the application can be employed to make the fracturing process itself more effective. In this embodiment, the energy of the MEPs is employed to further fracture the formation. By adding the energy of the MEPs to that which can be provided by the pumps, fracturing could be extended further than would be possible using the pumps alone resulting in a larger created fracture area which is essential for production from unconventional hydrocarbon fields such as shales.

It is well known in the unconventional oil and gas business that within 1-2 years, it is common that unconventional oil and gas wells can lose 80 percent of their production, requiring another round of hydraulic fracturing. Because of the costs of well “re-stimulation,” it would be desirable if this re-stimulation could be avoided, delayed, or performed at reduced cost. In another embodiment of the application, at least some of the MEPs could be left in place until such time that it would be desirable to re-stimulate the well in which they reside. At that time, they could be excited and the resulting energy employed to reopen blocked formations, eliminating or at least mitigating the need for re-fracturing.

After being put in place, the MEPs of the application could be excited using any method known to be useful to those of ordinary skill in the art. For example, the force of the MEPs entering the fracture fissures may be used in some embodiments. In other embodiments, the force of the fractures in the formation closing on the particles as the pressure is decreased at the end of a pumping segment of a hydraulic fracturing process can be used to excite the MEPs. For embodiments where a pressure wave or pulse is employed to excite the MEPs, the methods disclosed in the U.S. Provisional Patent Application filed concurrently herewith and having the title “System and Method for Using Pressure Pulses for Fracture Stimulation Performance Enhancement and Evaluation” and naming as inventors Daniel Moos and Silviu Livescu may be employed and is incorporated herein in its entirety by reference.

In still another application, a fluid within the fracturing process, such as an acid or base, could be used to excite the MEPs. Similarly, an accelerant or the second part of a binary explosive may be used by pumping it down into the formation at the time it would be desirable for the MEPs to be excited.

In one particularly desirable embodiment, the MEPs include a capsule that disintegrates over time. In this embodiment, after the capsule disintegrates, a triggering mechanism such as a pressure pulse is sent downhole to excite the MEPs. In a similar application, selected chemical agents used during fracturing also may have a disintegrating effect on the capsules allowing for a late excitation of the MEPs during a hydraulic fracturing process.

Generally speaking, it would be desirable if the MEPs were of a similar size to that of the proppant being used. The reasons for this include, but are not limited to compatibility of the MEPs with the proppant, especially during admixing of the proppant and MEPs; and the desire to avoid having the MEPs overrun or lag behind the proppant thereby misleading those attempting to map the extent of fracturing.

It follows then that it would be desirable that the MEPs have a mesh size of from about 12 to about 100 US mesh. In some embodiments, the MEPs would have size of about 30 US mesh.

The amount of MEPs used with a hydraulic fracturing process will vary depending upon the purpose for which it is being employed and type of geological formation into which it is being placed. Generally speaking, the amount of MEPs being employed will be from about 1 percent by weight to about 100 percent by weight of the amount of proppant being used.

Similar to hydraulic fracturing with proppants, in some carbonate formations, acid stimulation is used where acids such as mineral acids such as hydrochloric acid or organic acids such as acetic acid are pumped for acid fracturing applications. By having MEPs that are stable and compatible with acid fracturing fluids, applications similar to those explained above can be used.

In certain geological formations, it is difficult to initiate fractures due to near wellbore tortuosity. By pumping the MEPs ahead and exciting them prior to the actual fracturing treatment, the effect of near wellbore tortuosity can either be minimized or eliminated to allow more effective stimulation of the formation with the fracturing treatment. In another embodiment, a volume of MEP's is placed in and/or about the perforation tunnels/clusters and excited prior to pumping the fracturing treatment. In this embodiment, the MEP's can act to initiate fractures pre-treatment, thus aiding in elimination of unequal injection into the different perforation clusters being stimulated within a given hydraulic fracturing

It is common to stimulate coal bed methane wells by a cavitation process where in an open hole environment high pressure is used to stimulate these wells. By the use of the MEPs, the effectiveness of such a process can also be enhanced.

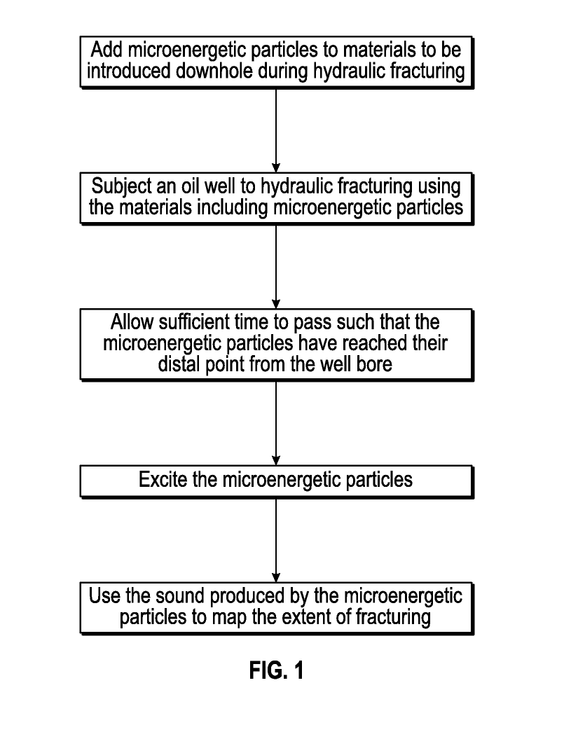

Turning now to the drawings, FIG. 1 is a flowchart illustrating one embodiment of a method of the application. In this embodiment, the MEPs are introduced downhole but not excited until the hydraulic fracturing process has reached as far as is planned. The MEPs are then excited and the noise from the resulting energy releases is used to map the extent of fracturing using conventional land seismic methods.

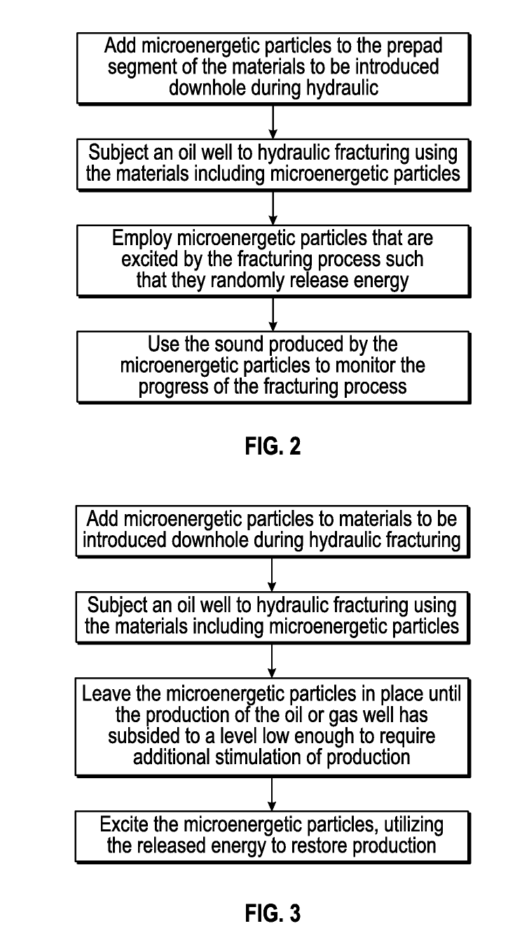

FIG. 2 illustrates an embodiment where the MEPs are introduced into the prepad segment of the fracture materials. This results in the MEPs being carried along at the forefront of the fracture generation during the fracture process. The MEPs used as selected such that they more or less continuously become excited so that there is sound generated at the fracture front. This embodiment allows for a more accurate monitoring of the fracture process as it is being preformed.

Turning to FIG. 3, an embodiment of a method of the Application is illustrated that allows for extending the time between stimulations of an oil or gas well. In this embodiment, the MEPs are put into place during hydraulic fracturing and left there until such time as the flow of oil or gas is reduced to the point that an operator would employ a new round of fracturing. Rather than hydraulically fracturing the well again, the MEPs already in place are excited and the resulting energy release reopens the fractures allowing for a restoration of flow.

While the above referenced embodiments are desirable, they by no means the only embodiments of the methods of the application within the scope of the claims.

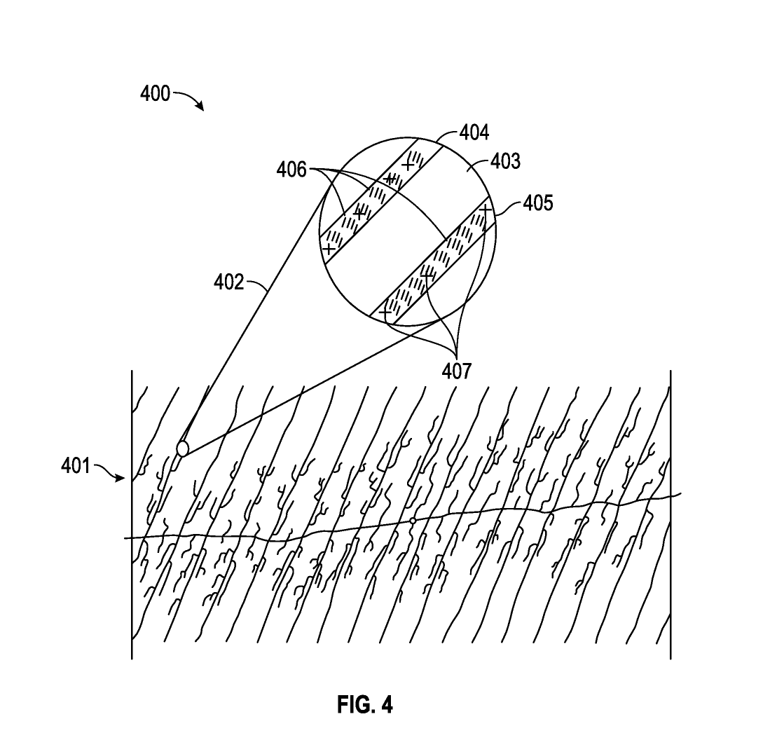

FIG. 4 is an illustration of a segment of an oil or gas reservoir 400 which has within it fractures created, at least in part, using hydraulic fracturing 401. The double arrow reference 402 shows a magnified section of the fractured reservoir. Therein 403 indicates the unfractured rock while 404 and 405 show fractures. The fractures are filled with proppant which is represented by crosshatch and has the reference number 406. The MEPs are shown to be present and are represented by the symbol “x” and have the reference number 407.

What is claimed is:

1. A method for performing hydraulic fracturing of an oil or gas well intersecting an earth formation comprising: including microenergetic particles with fluids and solids injected downhole during hydraulic fracturing of the oil or gas well.

2. The method of claim 1 further comprising exciting the microenergetic particles using a force selected from the group consisting of an electromagnetic force, a pressure wave in a wellbore of the oil or gas well, and combinations thereof.

3. The method of claim 1 further comprising exciting the microenergetic particles using a chemical agent.

4. The method of claim 1 further comprising exciting the microenergetic particles after the microenergetic particles are within fractures resulting from the hydraulic fracturing.

5. The method of claim 1 wherein the microenergetic particles are incorporated into a pad fluid.

6. The method of claim 1 wherein a sound resulting from exciting the microenergetic particles is used to monitor the extent of fracturing.

7. The method of claim 1 wherein the energy resulting from exciting the microenergetic particles is employed to further fracture the earth formation.

8. The method of claim 1 wherein at least some of the microenergetic particles are left in place until such time as the oil or gas well needs to be subjected to re-stimulation.

9. The method of claim 8 further comprising exciting the microenergetic particles under conditions such that a resulting energy from the microenergetic particles increases hydrocarbon production to an extent sufficient to mitigate or at least delay the need for re-stimulation.

10. The method of claim 1 wherein at least some of the microenergetic particles are employed to eliminate or at least mitigate near wellbore tortuosity.

11. A composition useful for performing hydraulic fracturing of an oil or gas well comprising: a member selected from the group consisting of proppants, gelling compounds, gel breakers, and combinations thereof; and microenergetic particles at a concentration sufficient to improve at least one aspect of hydraulic fracturing of an oil or gas well performed therewith.

12. The composition of claim 11 wherein the microenergetic particles are in a form selected from the group consisting of neat particles, particles which have been encapsulated, particles which have been adhered to a support, and combinations thereof.

13. The composition of claim 11 wherein the microenergetic particles are in the form of a supported particle and the support is alumina.

14. The composition of claim 12 wherein the microenergetic particles are in the form of a particle encapsulated using a polymer.

15. The composition of claim 12 wherein the microenergetic particles are an explosive or propellant.

16. The composition of claim 15 wherein the explosive or propellant is selected from the group consisting of nitro-aromatics such as trinitrotoluene and trinitrophenol;
nitramines such as cyclotetramethylenetetranitramine (also known as HMX), aliphatic nitro compounds such as nitrocellulose, nitroglycerine, and nitrated polyols; hydrazines;
perchloric acid; powdered aluminum; powdered magnesium; and combinations thereof.

17. The composition of claim 15 wherein the explosive or propellant is selected from the group consisting of dinol, dinitrodihydroxydiazobenzene salt (diazinate), dinitrobenzofuroxan salts, perchlorate or nitrate salt of metal complexes of ammonium, amine, and hydrazine.

18. The composition of claim 15 wherein the explosive or propellant is a mixture of 2-(5-cyanotetrazolato)pentaaminecobalt (III) perchlorate (CP), and various diazo, triazole, and tetrazole compounds.

19. The composition of claim 1 wherein the solids comprise proppants.

20. A method for performing hydraulic fracturing of an oil or gas well comprising admixing microenergetic particles with fluids and solids injected downhole during hydraulic fracturing of the oil or gas well and then exciting the microenergetic particles such that at least some of the particles release energy.
